(19) United States
(12) Patent Application Publication
(10) Pub. No.: US 2002/0074323 A1
(43) Pub. Date: Jun. 20, 2002

(54) Multi-functional oven for cooking food

(75) Inventor: Giuseppe De' Longhi, Treviso (IT)

Correspondence Address: THE FIRM OF KARL F ROSS, 5676 RIVERDALE AVENUE, PO BOX 900, RIVERDALE (BRONX), NY, 10471-0900, US

(73) Assignee: DE' LONGHI S.p.A.

(21) Appl. No.: 09/992,487

(22) Filed: Nov. 14, 2001

(30) Foreign Application Priority Data
Nov. 22, 2000 (IT) MI2000A002510

(51) Int. Cl. A21B 1/26

(52) U.S. Cl. 219/400; 126/21 A

(57) ABSTRACT

A multi-functional oven (1) for cooking food comprises a case (2) wherein are housed: a lower plate (3) which separates a baking chamber (4) from a heating chamber (5) wherein are housed resistor heating means (6), and at least one side plate (7) equipped with first through-openings (8, 9) which separates the baking chamber (4) from a circulation chamber.

The oven (1) comprises a fan suitable for keeping in circulation the air inside of the oven, making it pass through the first through-openings (8, 9) and first conveyance means (10) of the air from the circulation chamber to the heating chamber (5), and second conveyance means (16) of the air from the heating chamber (5) to the baking chamber (4).

### DESCRIPTION

The present invention refers to a multi-functional oven for cooking food, in particular one which is electrically powered.

As is known electric ovens of different types currently exist:

static ovens, which comprise a case wherein heating resistors suitable for cooking food are housed.

fan-assisted ovens, which have characteristics similar to those of static ovens and in addition comprise a fan suitable for keeping the air circulating inside the oven itself;

multi-functional ovens, which have an analogous structure to that of fan-assisted ovens and, moreover, are equipped with an additional resistor at the air intake, suitable for heating the air which is kept in circulation in the oven.

Multi-functional ovens comprise a very large number of components and, in particular, the presence of the additional resistor makes such ovens very expensive.

Moreover, since during operation both the cooking resistors and the additional resistor have to be supplied with electricity, the wattage of traditional multi-functional ovens is very high.

The technical task asked of the present invention is, therefore, that of eliminating the stated technical drawbacks of the prior art, realising a multi-functional oven for cooking food which has a restricted number of components and, in particular, which does not have the additional resistor, still improving the cooking characteristics of traditional multi-functional ovens and in particular the uniformity of the heating of the food.

In this technical task a purpose of the invention is that of realising a multi-functional oven which has a restricted wattage with respect to traditional multi-functional ovens.

The last but not least purpose of the invention is that of realising a multi-functional oven which has a very flexible operation and, in particular, which can also operate as a static oven or as a fan-assisted oven.

The technical task, as well as these and other purposes, according to the present invention are achieved by realising a multi-purpose oven for cooking food comprising a case wherein are housed: a lower plate which separates a baking chamber from a heating chamber wherein is housed resistor heating means, and at least one side plate equipped with first through-openings which separates said baking chamber from a circulation chamber, said oven comprising a fan suitable for keeping the air in circulation inside of it, making it pass through said through-openings, characterised in that it comprises first means for conveying said air from said circulation chamber to said heating chamber and a second means for conveying said air from said heating chamber to said baking chamber.

Other characteristics of the present invention are defined, moreover, in the claims which follow.

Further characteristics and advantages of the invention will become clearer from the description of a preferred but not exclusive embodiment of the multi-functional oven for cooking food according to the finding, illustrated for indicating and not limiting purposes in the attached figures, wherein:

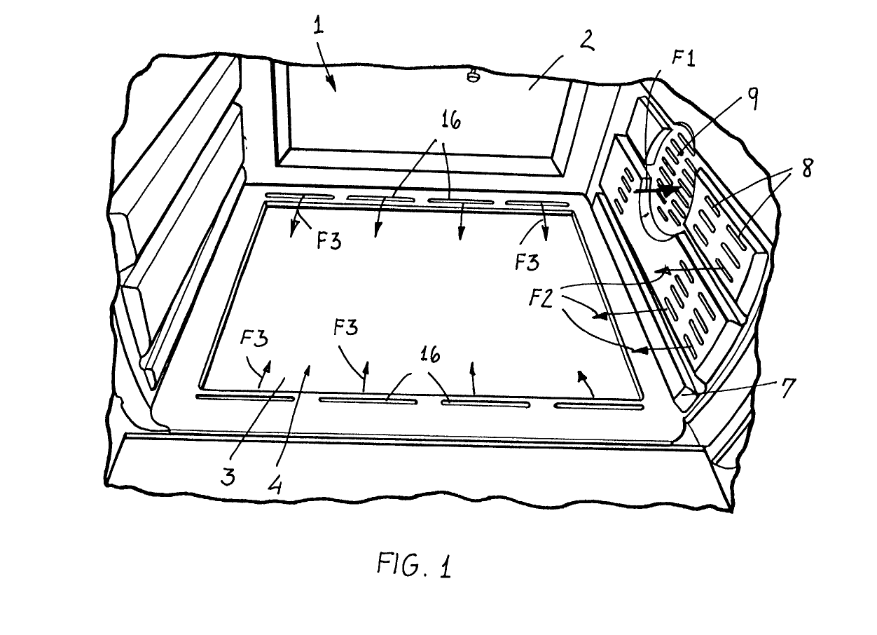

FIG. 1 shows a perspective view of a baking chamber of the oven according to the finding;

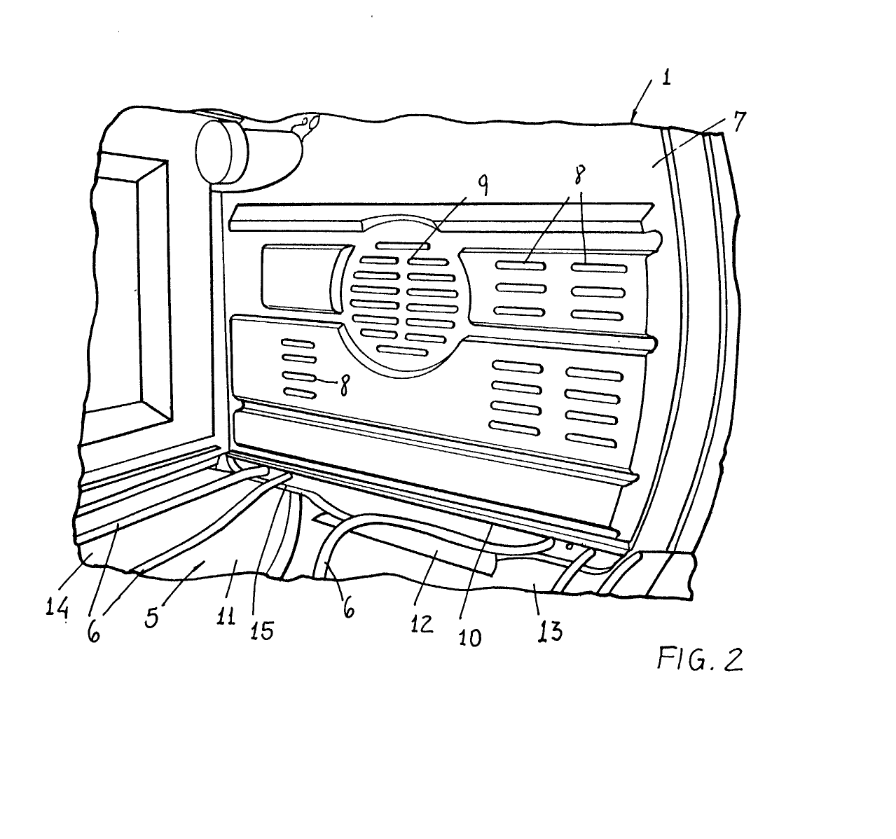

FIG. 2 shows a detail of a plate which forms the side border of the baking chamber;

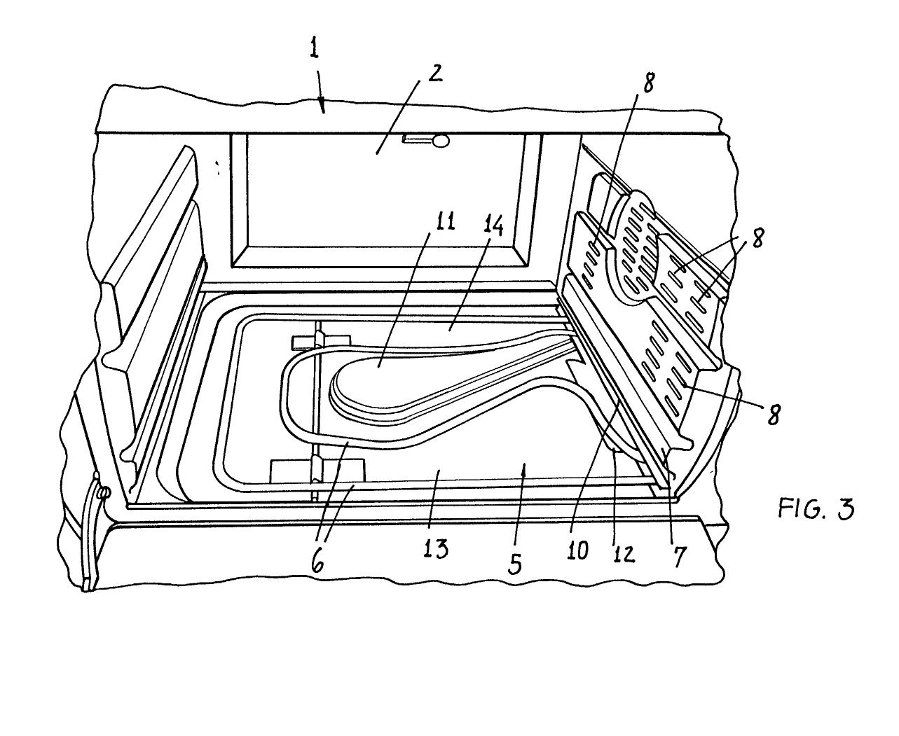

FIG. 3 shows a perspective view of an inner portion of the oven according to the finding, without a lower plate which separates a heating chamber from the baking chamber;

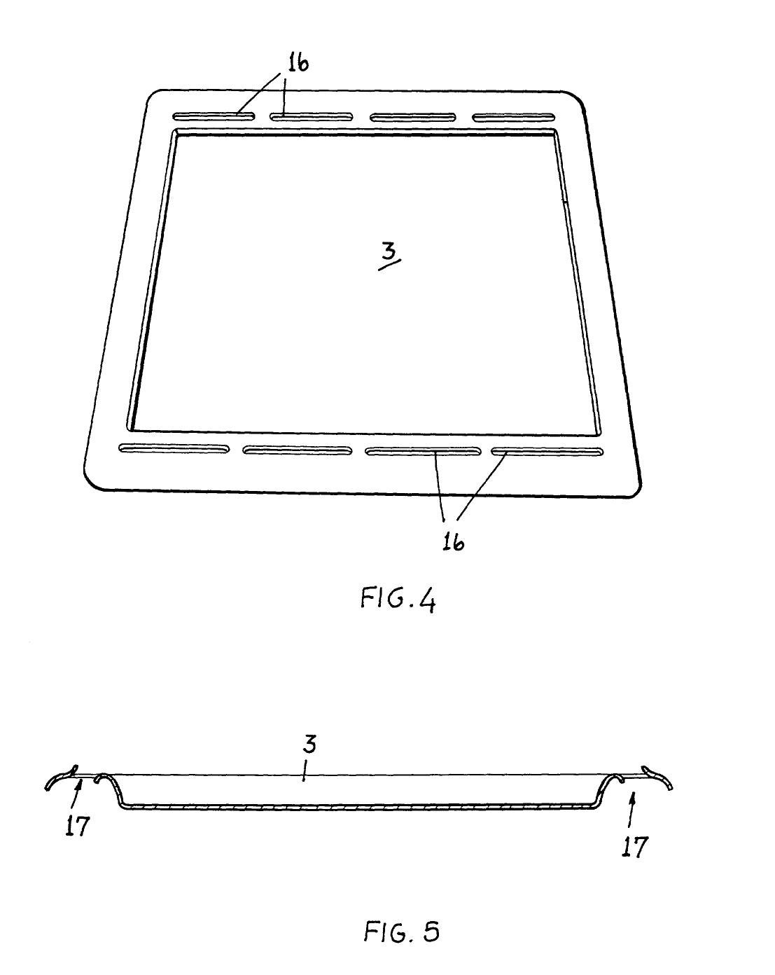

FIG. 4 shows a perspective view of the lower plate according to the finding;

FIG. 5 shows a cross-section of the plate according to the finding; and

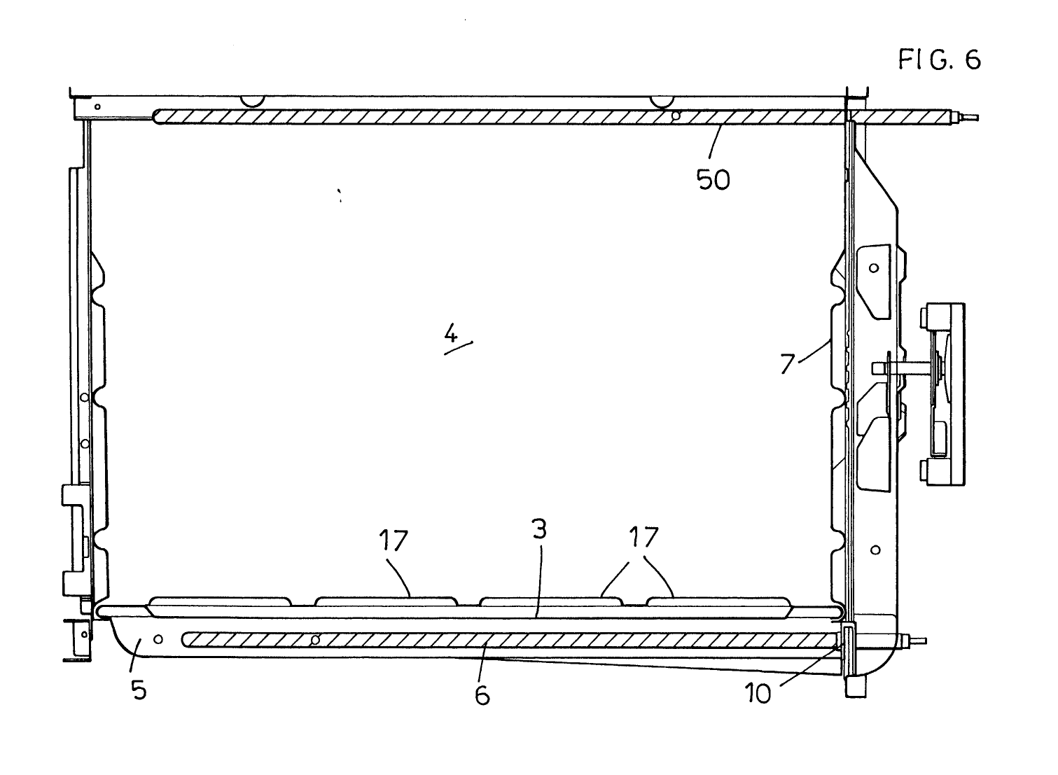

FIG. 6 shows a section of the oven according to the finding.

With reference to the quoted figures, a multi-functional oven for cooking food is shown, wholly indicated with the reference number 1.

The oven 1 comprises a case 2 wherein is housed a lower plate 3 consisting of a waste collection element which can be removed from the case 2.

The lower plate 3 separates a baking chamber 4 from a heating chamber 5 wherein is housed resistor heating means 6, consisting of an electrical resistance. Moreover, the oven 1 comprises a further electrical resistance 50 at an upper wall of the case 2.

Inside the case 2 is also housed a side plate 7, equipped with first through-openings 8 and 9, which separates the baking chamber 4 from a circulation chamber (arranged between the plate 7 and the side wall of the case 2).

In the circulation chamber is housed a fan (at the central through-openings 9) which is suitable for putting and keeping the air inside the oven 1 in circulation. The oven 1 comprises, interposed between the circulation chamber and the baking chamber 4, first conveyance means through which the air passes to go from the circulation chamber to the baking chamber 4.

Such first conveyance means comprises a passage 10 interposed between the circulation chamber and the heating chamber 5.

The heating chamber 5 has at least one deflector 11 which defines a preferential path for the air which circulates in the heating chamber 5, with the passage 10 arranged at one inlet end of such a preferential path.

Moreover, at the same passage 10, the oven 1 has intercepting means suitable for preventing the passage of air through the passage 10.

Such intercepting means comprises, for example, a foil 12 hinged to the plate 3 at the passage 10, so as to take up one position wherein the passage 10 is closed and another position wherein the passage 10 is open.

Advantageously, the preferential path has an inlet branch 13 with passage sections which are substantially bigger with respect to those of the outlet branch 14, to guide the air and promote its heating and passage in the baking chamber 4. Moreover, the passage 10 is arranged at the inlet branch 13, whilst the outlet branch 14 ends with a blind wall 15.

The deflector 11 comprises, in the example shown, a single-piece shaped and raised portion realised integral with a base of the case 2. Such a solution allows the air to be guided and, at the same time, eases the cleaning and maintenance operations of the heating chamber 5.

Moreover, the lower plate 3 is rested upon the deflector 11.

In different examples of embodiments, however, the deflector 11 takes up a different conformation and consists, for example, of a slanting foil. The electrical resistance 6 has an extension in the inlet branch 13 which is greater than that in the outlet branch 14.

Indeed, in this way, the air undergoes an intense heating when it enters the heating chamber 5; subsequently, due to the shortened extension of the resistor 6 (and thus the shorter time in contact with it) the temperature of the air which flows in the baking chamber 4 through second conveyance means 16 is kept substantially constant.

Moreover, the greater length of the electrical resistance 6 increases the irradiation in the baking chamber 4 through the lower plate 3.

In a preferred embodiment, the inlet branch 13 of the preferential path is arranged at an inlet opening to the oven and, moreover, the electrical resistance 6 has at least one portion which runs along the opening 10.

The lower plate 3 has a plurality of second through-openings 16, as second conveyance means, which allow the passage of the air from the heating chamber 5 to the baking chamber 4.

In different examples the openings 16 can also comprise edge recesses, etc. Such openings 16 are realised at a front edge and a rear edge of the lower plate 3 (with reference to the plate 3 housed in the oven 1).

Moreover, the openings 16 have deflectors 17 for the conveyance of the air towards the centre of the baking chamber 4.

The deflectors 17 comprise an edge protruding towards the base of the plate 3, and another edge protruding in the opposite direction.

Moreover, the lower plate 3 can be realised capable of sliding, preferably along a side wall of the case 2 and along the side plate 7 to ease its removal and cleaning. The operation of the multi-functional oven for cooking food according to the finding is clear from that which has been described and illustrated and, in particular, is substantially the following.

The oven 1 can operate as a multi-functional oven, as a fan-assisted oven and as a static oven and is, therefore, very flexible.

In the operation as a multi-functional oven, the fan is activated and the passage 10 is left free and not closed by the foil 12.

In this way the lower resistor 6 and the upper resistor 50 heat the oven and, at the same time the fan sucks air through the central openings 9 (as indicated by the arrow F1) and expels it again into the baking chamber 4 through the openings 8 (as indicated by the arrows F2).

Moreover, a part of the air sucked in by the fan goes through the passage 10 and is introduced inside the heating chamber 5.

When it enters the heating chamber 5 the air undergoes an intense heating through the operation of the electrical resistances 6.

Therefore, the air follows the preferential path and goes through the second through-openings 16 of the lower plate 3 passing from the heating chamber 5 to the baking chamber 4 (as indicated by the arrows F3).

When the air goes along the preferential path after the initial intense heating, its temperature is kept substantially constant and, thus, the heating of the food contained in the baking chamber 4 is very uniform guaranteeing an excellent cooking.

In the operation as a fan-assisted oven the foil 12 closes the passage 10 completely.

In this case the oven is heated by the lower and upper resistor, 6 and 50 respectively, and inside of it the fan keeps the air in circulation, passing from the baking chamber 4 to the circulation chamber through the openings 9 (as indicated by the arrow F1) and from the circulation chamber to the baking chamber 4 through the openings 8 (as indicated by the arrows F2).

Finally, not activating the fan, the oven can be used as a static oven.

In this case the baking chamber 4 is heated exclusively by the lower resistor 6 and by the upper resistor 50.

In practice it has been noted how the multi-functional oven for cooking food according to the invention is particularly advantageous because it requires lower production costs and has a lower wattage with respect to traditional ovens, at the same time improving the distribution of the heat and the uniformity of the heating of the food.

Moreover, the multi-functional oven according to the finding has a very flexible operation, also being able to operate as a static or fan-assisted oven.

The multi-functional oven for cooking food thus conceived is susceptible to numerous modifications and variants, all of which fall within the inventive concept; moreover, all of the details can be replaced by technically equivalent elements.

In its realisation, the materials used, as well as the sizes, can be whatever according to the requirements and the state of the art.

1. Multi-functional oven (1) for cooking food comprising a case (2) wherein are housed: a lower plate (3) which separates a baking chamber (4) from a heating chamber (5) wherein is housed resistor heating means (6), and at least one side plate (7) equipped with first through-openings (8, 9) which separates said baking chamber (4) from a circulation chamber, said oven (1) comprising a fan suitable for keeping in circulation the air inside of it, making it pass through said first through-openings (8, 9), characterised in that it comprises first conveyance means (10) of said air from said circulation chamber to said heating chamber (5), and second conveyance means (16) of said air from said heating chamber (5) to said baking chamber (4).

2. Oven (1) according to claim 1, characterised in that said first conveyance means (10) comprises at least one passage interposed between said circulation chamber and said heating chamber (5).

3. Oven (1) according to one or more of the previous claims, characterised in that said heating chamber (5) has at least one deflector (11) which defines a preferential path (13, 14) for said air, said passage (10) being arranged at an inlet end of said preferential path (13, 14).

4. Oven (1) according to one or more of the previous claims, characterised in that said lower plate (3) is rested upon said deflector (11).

5. Oven (1) according to one or more of the previous claims, characterised in that it comprises interception means (12) suitable for preventing the passage of air through said passage (10).

6. Oven (1) according to one or more of the previous claims, characterised in that said preferential path (13, 14) has an inlet branch (13) with substantially larger passage sections with respect to those of an outlet branch (14).

7. Oven (1) according to one or more of the previous claims, characterised in that said deflector (11) comprises a shaped raised portion on a base of said case (2).

8. Oven (1) according to one or more of the previous claims, characterised in that said resistor heating means (6) has a substantially larger extension in said inlet branch (13) than in said outlet branch (14).

9. Oven (1) according to one or more of the previous claims, characterised in that said inlet branch (13) of said preferential path (13, 14) is arranged at an inlet opening to said baking chamber (4) of said oven.

10. Oven (1) according to one or more of the previous claims, characterised in that said resistor heating means (6) comprises at least one electrical resistance which has at least a portion thereof which runs along said passage (10).

11. Oven (1) according to one or more of the previous claims, characterised in that said second conveyance means (16) comprises second openings (16) realised at opposing edges of said lower plate (3).

12. Oven (1) according to one or more of the previous claims, characterised in that said second openings (16) of said lower plate (3) are realised at a front and a rear edge thereof.

13. Oven (1) according to one or more of the previous claims, characterised in that said second openings (16) of said lower plate (3) have deflectors (17) for conveying the air.

14. Oven (1) according to one or more of the previous claims, characterised in that said fan is housed in said circulation chamber.

15. Multi-functional oven (1) for cooking food as described and claimed.
